(19) United States
(12) Patent Application Publication
(10) Pub. No.: US 2026/0162408 A1
(43) Pub. Date: Jun. 11, 2026

(54) PROGRESSIVE IMAGE DATA CURATION FOR IMPROVED TRAINING IMAGE QUALITY

(71) Applicant: Walmart Apollo, LLC, Bentonville, AR (US)

(72) Inventors: Feiyun Zhu, Plano, TX (US); Wei Wang, Dallas, TX (US); Lingfeng Zhang, Flower Mound, TX (US); Mingquan Yuan, Flower Mound, TX (US); Zhaoliang Duan, Frisco, TX (US); Xin Ma, Arlington, TX (US); Huanyu Zang, Frisco, TX (US); Colin Grant Mitchell, Wills Point, TX (US); Yanmei Jin, Dallas, TX (US); William Craig Robinson, Centerton, AR (US); Han Zhang, Allen, TX (US)

(21) Appl. No.: 19/178,674

(22) Filed: Apr. 14, 2025

Related U.S. Application Data
(60) Provisional application No. 63/634,560, filed on Apr. 16, 2024.

(51) Int. Cl. G06V 10/774; G06T 7/11; G06V 20/50

(52) U.S. Cl. CPC G06V 10/7747; G06T 7/11; G06V 20/50; G06T 2207/20081

(57) ABSTRACT

Examples provide a system for generating image-based training data using progressive data curation. An anchor image of a selected item and historical receipts including the selected item generated during a dynamic receipt retrieval time period are obtained. Images of the carts including the selected item paired with the receipts are analyzed and cropped to isolate the selected item from each cart image. An embedding model generates embeddings representing the anchor image and the cropped images of the selected item. A similarity of the cropped image embeddings to the anchor image embedding is calculated using a similarity metric. The cropped image embeddings are ranked based on the calculated similarity to the anchor image. The images having the highest rank and greatest similarity to the anchor image are selected for inclusion in training data used to train computer vision models to detect and/or recognize the selected item in images of various objects.

### BACKGROUND

Computer vision (CV) object detection and recognition models can be used to automatically analyze images of objects and identify the objects in each image, such as images of products in a retail store. Computer vision object detection and recognition models are trained using images of the objects which the user wants the model(s) to automatically detect and/or recognize. Retail stores frequently handle a vast array of products, sometimes including thousands or tens of thousands of different products. This diversity presents a significant challenge when it comes to gathering a sufficient number of high-quality training images for each product to be used during training of the CV models. Human labelers can be employed to manually review images of products and hand-label the images for use as training data. However, obtaining a sufficient number of high quality training images can require manual review and labeling of dozens or even hundreds of images of each product. Moreover, it can be very difficult to collect real-time data for rare occurrence items, mainly due to the item data for these rare items being submerged in a vast amount of data associated with potentially thousands of items purchased during hundreds of transaction at each retail facility each day. Thus, obtaining accurately labeled image data for training CV models can be a highly time-consuming, inefficient, and potentially cost-prohibitive process.

### SUMMARY

Some examples provide a system and method for automatically generating high quality, image-based training data using progressive data curation with historical data. An item is selected for which additional training data images are desired. An anchor image of the selected item is obtained. Receipts including an item identifier (ID) associated with the selected item which were generated during a dynamic retrieval time period are selected from a plurality of receipts. Each receipt is paired with a cart expected to include the selected item. The cart is associated with a cart image. The cart image is cropped to isolate the images of individual items, including the selected item. An anchor image embedding representing the anchor image is generated. A cropped image embedding is generated for each cropped image of the selected item. A similarity metric is used to calculate the similarity between the anchor image embedding and each cropped image embedding. The cropped image embeddings are ranked based on the calculated similarity. The anchor image embedding is updated by integrating a set of highest similarity cropped image embeddings from the cropped image embeddings using the calculated similarity. The system iteratively calculates the similarity between the updated anchor image embedding and the cropped image embeddings, ranks the cropped image embeddings based on the calculated similarity, and updates the anchor image embedding until a convergence of cropped image embedding ranking is achieved. A threshold number of cropped images of the selected item corresponding to a set of highest similarity cropped image embeddings are selected based on the rankings.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for progressive data curation using historical data to generate quality training data including images of selected items.

FIG. 2 is an exemplary block diagram illustrating a retail facility including image capture devices and checkout terminals for generating receipts and cart images.

FIG. 3 is an exemplary block diagram illustrating an image manager for generating image-based training data using progressive data curation.

FIG. 4 is an exemplary block diagram illustrating a pipeline of progressive data curation for generating images of a selected item for use in training data.

FIG. 5 is an exemplary diagram illustrating a set of images of a selected item created without progressive data curation and with progressive data curation.

FIG. 6 is an exemplary flow chart illustrating operation of the computing device to generate sets of images for training data using progressive data curation.

FIG. 7 is an exemplary flow chart illustrating operation of the computing device to iteratively update anchor image embeddings and ranking cropped image embeddings based on calculated similarity during progressive data curation.

FIG. 8 is an exemplary flow chart illustrating operation of the computing device to apply a dynamic retrieval time period based on frequency with which each selected item is included in receipts associated with purchase transactions.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Retail facilities frequently stock a large number of different products in inventory which are available for purchase by customers. Each day, hundreds or thousands of images of these products can be generated by cameras capturing images of shopping carts at checkout and/or robotic devices roaming the facility and capturing images of the products on the store shelves. However, these images are typically noisy, including several different products in each image, with objects overlapping each other. Products in images can sometimes be obscured by the shopping cart or other objects in the cart. These noisy images should not be used for training deep learning models because these images, if not manually confirmed and labeled, can introduce numerous errors, leading to a negative impact on the model's performance.

Moreover, the number and types of products appearing in the images can be highly imbalanced. With thousands of different products available for purchase at a variety of different price points, some common items are purchased more frequently while other less common items are purchased infrequently. The frequently purchased common items appear in cart images at a much higher rate than the less frequently purchased uncommon items. Thus, some items appear in many images captured each day while other less frequently purchased items are represented in only a few, if any, images. The data collected can be very imbalanced making the data sets of cart images generated each day unsuitable for use as training data without additional processing.

Obtaining a sufficient number of high quality training images for use in training one or more object detection models to detect hundreds or thousands of different items (products) can be challenging due to the sheer volume of item images that have to be processed, which can include hundreds of images for each item in an assortment of thousands of items. Moreover, these images frequently contain noise, making them more difficult to classify. Noise can include images of carts, shelving, fixtures, or any other objects which are not the object of interest (selected item) for which training images are desired. In addition, the distribution of these images can frequently be imbalanced, where images of some items are plentiful while images of other items are relatively scarce. This further complicates the task of generating data sets of high quality training images for use in training computer vision (CV) object detection and/or objection recognition models.

Referring to the figures, examples of the disclosure enable progressive data curation using historical data, such as purchase receipts and cart images generated within a dynamic retrieval time period. In some examples, the system uses a similarity metric, such as a cosine similarity metric, to calculate the similarity between an anchor image embedding of a selected item and cropped image embeddings representing cropped images of the selected item. The calculated similarity values are used to rank the cropped images of the selected item and select the highest quality images of the selected item for use in training data. This enables automatic generation of training data sets including a variety of images of items used to train computer vision object detection models with reduced cost and greater efficiency that is also less burdensome for human users.

The system further calculates a similarity score and a similarity ranking to image embeddings, ensuring that the highest quality and most suitable images of items are automatically selected for use in training data. This reduces memory usage consumed by storing unsuitable, poor quality images. It further reduces time spent by human users manually removing poor-quality images from the data sets of images which are automatically generated for use in training data for improved user interaction performance.

Other aspects of the system enable application of a dynamic retrieval time period which is adjusted or selected based on the frequency with which a selected item is detected within receipts and/or cart images. The retrieval time period is longer for uncommon items that are purchased at a lower frequency. This enables the system to retrieve receipts including the less-common items during a longer time period than for items that are more commonly found in purchase receipts ensuring adequate numbers of receipt-cart image pairs.

The computing device operates in an unconventional manner by using progressive data curation with historical data to iteratively update anchor image embeddings using the highest ranking cropped image embeddings, ensuring the highest quality images of items are selected for use in training data without human user intervention. The results are presented to users for review and verification via a user interface. In this manner, the system allows improved human interaction via the user interface while reducing the error rate associated with automated item image curation and memory usage associated with storing poor-quality images which are unsuitable for use as training data, thereby improving the functioning of the underlying computing device.

Leveraging historical receipt information allows the system to gather a more extensive and diverse set of data for all items and/or all item universal product codes (UPCs). Extending the retrieval time period facilitates the collection of more images for less common UPCs, thereby addressing the imbalance issue in the training data. This approach of progressively updating the anchor image embedding and ranking of cropped image embeddings improves ranking quality, which in turn enhances the quality of item images used for training computer vision object detection and/or object recognition models.

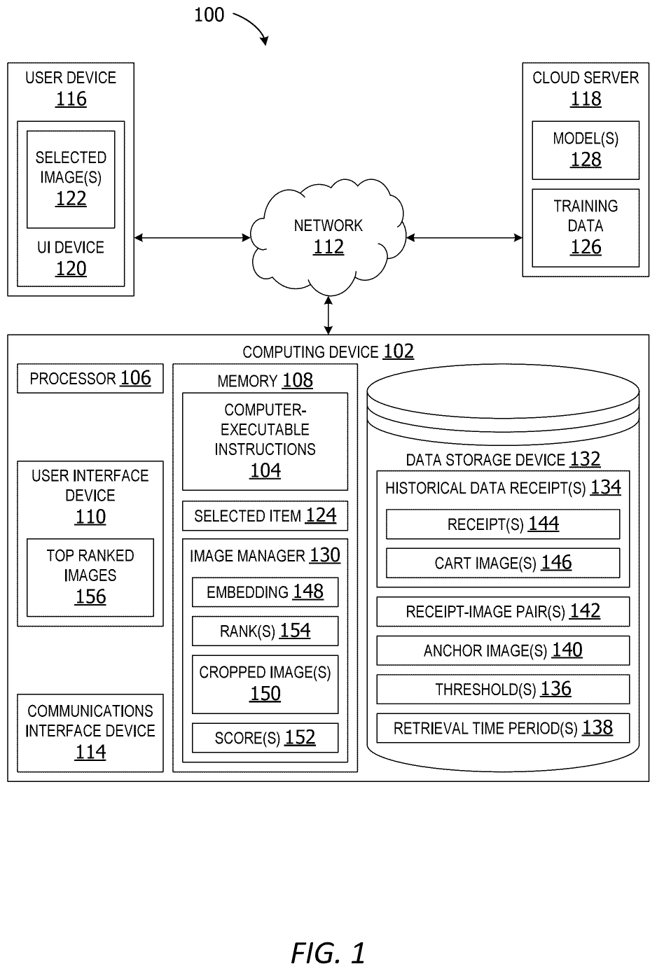

Referring again to FIG. 1, an exemplary block diagram illustrates a system 100 for progressive data curation using historical data to generate quality training data including images of selected items. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

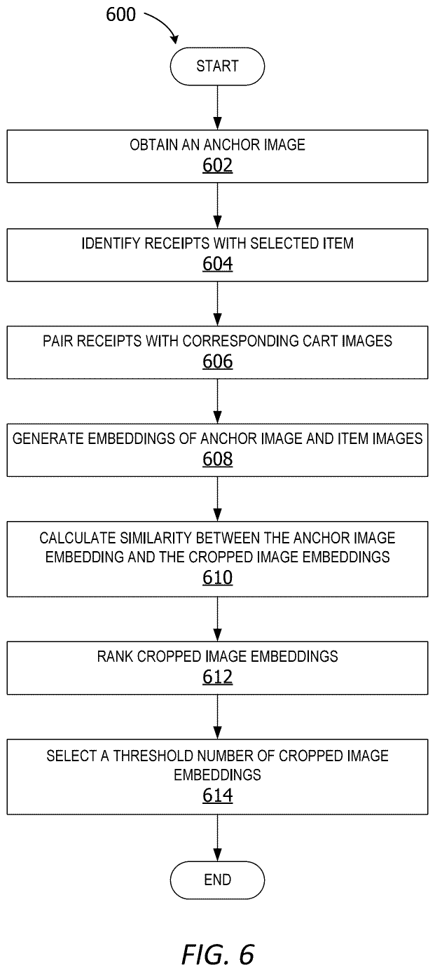

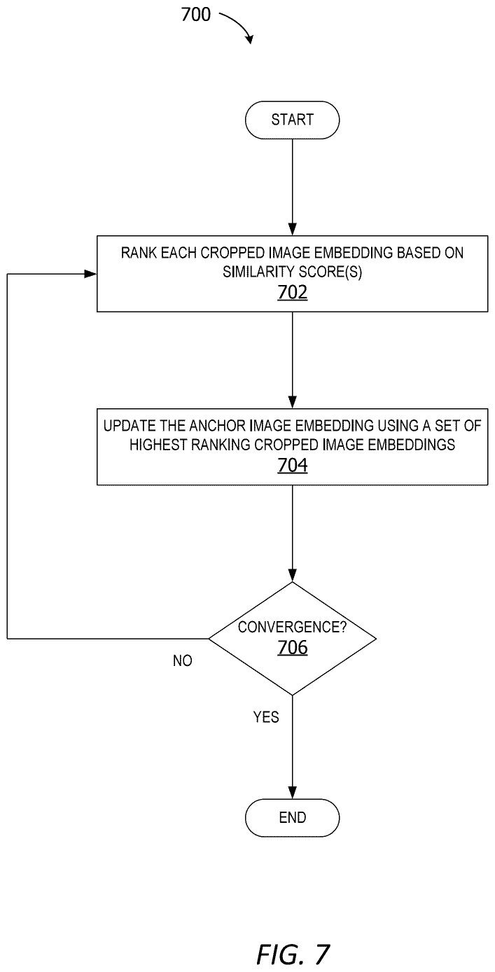

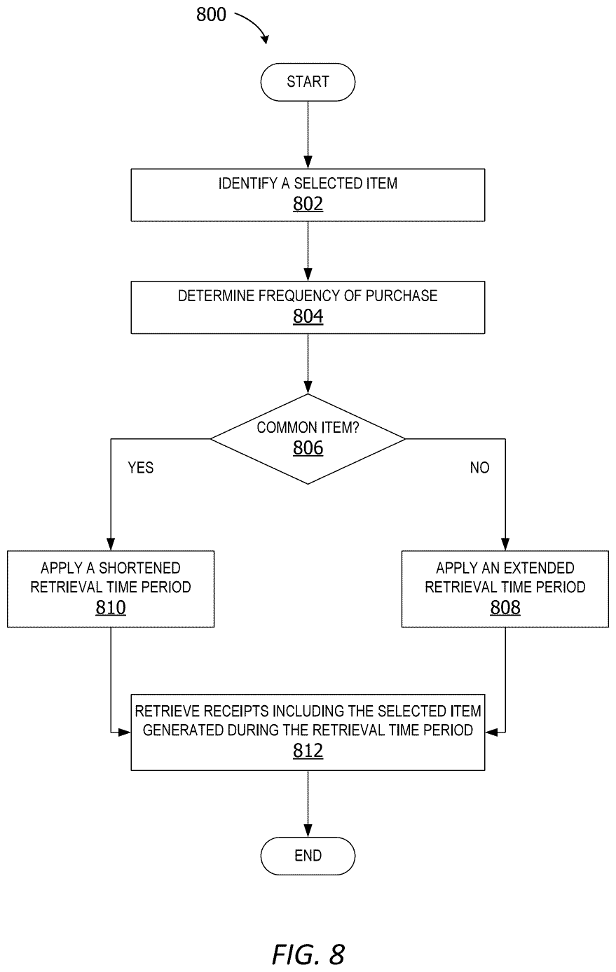

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, and FIG. 8).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown).

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120 for presenting data to a user, such as, but not limited to, one or more selected image(s) 122 of a selected item 124 obtained using progressive data curation with historical receipt and cart image data.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In some examples, the cloud server 118 includes a cloud storage for storing data, such as, but not limited to, training data 126. The training data 126 in this example includes the selected image(s) which have been reviewed and/or verified by one or more human users via the user device 116. The selected image(s) 122 are selected by an image manager 130 software component performing progressive data curation using historical data. The verified images are included in the training data 126. Verification includes a human user verifying the cropped image is an image of the selected item or a portion of the selected item and/or verifying the image is accurately labeled as the selected item. Labeling the image can include a name of the item in the image, an item ID or UPC, a description of the item in the image, etc. Any unverified images are optionally discarded or manually re-labeled by one or more human users.

The training data 126 is used to train one or more deep learning model(s) 128, such as, but not limited to, object recognition model(s) and/or object detection model(s)r. An object detection model is any type of computer vision (CV), deep learning, neural network model for analyzing images and detecting objects-of-interest within those images automatically without human intervention. The object detection model includes a convolutional neural network (CNN) object detection model implemented on a CV item recognition as a service (IRAS) platform. In some examples, the object detection model places bounding boxes around the objects-of-interest which are detected in each image. An object recognition model is any type of CV, deep learning, neural network model for recognizing items/objects in images. An object recognition model can be referred to as an image recognition model, an item recognition model, and/or a classification model.

The system 100 can optionally include a data storage device 132 for storing data, such as, but not limited to historical data 134, threshold(s) 136, retrieval time period(s) 138, anchor image(s) 140, and/or receipt-image pair(s) 142. The historical data 134 includes transaction purchase receipt(s) 144 and/or cart image(s) 146 generated during a pre-determined previous time period. The receipt(s) 144 include receipts generated by manned checkout terminals, self-checkout terminals, as well as any other type of point-of-sale (POS) device. The receipt(s) 144 can include paper receipts, electronic receipts, as well as any other type of receipt associated with purchase of one or more items from a retail facility. Each receipt includes an item identifier (ID) for each purchased item, such as, but not limited to, a universal product code (UPC), matrix barcode, digital watermark, or other item identifier.

In some embodiments, each receipt is paired with a shopping cart expected to include a selected item identified in the receipt. The system obtains one or more images of the paired shopping cart. These cart images are used to obtain cropped images of each item in the shopping cart paired to the receipt. In other words, each receipt is paired with a cart expected to contain the corresponding UPC/item, but the presence of the UPC image in the cart image isn't always guaranteed due to occlusion.

The cart image(s) 146 include one or more images of customer carts containing one or more items purchased during a transaction. The cart image(s) 146 can include baskets, bags, shopping carts (buggies), or any other type of cart or container used to hold purchased items. The cart image(s) 146 are paired with purchase receipts corresponding to each image in the receipt-image pair(s) 142.

The data storage device 132 can include one or more different types of data storage devices, such as, for example, one or more rotating disks drives, one or more solid state drives (SSDs), and/or any other type of data storage device. The data storage device 132 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 132 includes a database.

The data storage device 132 in this example is included within the computing device 102, attached to the computing device, plugged into the computing device, or otherwise associated with the computing device 102. In other examples, the data storage device 132 includes a remote data storage accessed by the computing device via the network 112, such as a remote data storage device, a data storage in a remote data center, or a cloud storage.

The memory 108 in some examples stores the image manager 130 component that, when executed by the processor 106 of the computing device 102, obtains one or more anchor image(s) 140 for a selected item identifier (ID) associated with the selected item 124 in a retail facility. The anchor image is a representative image of the selected item. The anchor image in some examples is obtained from one or more online sources via an online search engine or other search query. In still other examples, the anchor image is generated by a model, such as a contrastive language-image pretraining (CLIP) model. A CLIP model is a neural network trained on image-text pairs to generate images based on textual input, such as a text description of the selected item 124. In other examples, pre-labeled images (previously generated labeled images) already available in data storage are used to generate or obtain anchor images as these images created by human labelers are also trusted images.

In some examples, the image manager 130 identifies a set of one or more receipt(s) 144 from a plurality of receipts that contains the selected item ID, such as the item UPC. Each receipt containing the selected item ID is paired with a cart image corresponding to the basket of items purchased in the receipt. The cart image includes an image of a customer cart and one or more items inside the cart, such as the selected item 124. Each item image is cropped from a cart image in the cart image(s) 146 to isolate the image or portion of the image of the selected item in each cart image and/or eliminate noise from the cropped item images.

The image manager 130 generates embeddings 148. The embeddings 148 include an anchor image embedding representing the anchor image and a cropped image embedding representing the image of the portion of the selected item in each of the cropped image(s) 150. In other examples, the embeddings 148 are generated by an embedding model. The cropped image(s) 150 including images of items cropped from one or more cart images.

The image manager 130 calculates a similarity between the anchor image embedding and a plurality of cropped image embeddings using a similarity metric, such as, but not limited to, a cosine similarity metric and/or a Euclidean distance metric. However, the embodiments are not limited to a cosine similarity metric or Euclidean distance metric. In other embodiments, any metric can be used for calculating the similarity between two vectors or embeddings.

The calculated similarity value in some examples include one or more similarity score(s) 152. The embeddings 148 representing the cropped image(s) 150 are ranked based on the calculated similarity score(s) 152. The rank(s) 154 assigned to each cropped image embedding indicates a degree of similarity or ranking of similarity to the anchor image embedding. In some examples, the rank(s) are assigned to the embeddings. In other examples, the rank(s) are assigned to the cropped images represented by the embeddings. The top ranked images 156 are selected for inclusion in the training data set of images for the selected item 124. The higher the rank of the image, the closer the image content is to the anchor image.

The image manager 130 in some examples selects a threshold number of cropped images from the plurality of cropped images corresponding to a set of highest similarity cropped image embeddings from the plurality of cropped image embeddings. The threshold is a user-configurable threshold from the one or more threshold(s) 136. The selected threshold number of cropped images are added to the training data 126 for the selected item 124. The training data is labeled training data including multiple different cropped images of the selected item obtained from the cart images. The labeled training data is optionally stored in a database, such as a relational database in a data storage device 132 and/or on the cloud server 118. A CV object detection model is trained using the training data including the selected threshold number of cropped images.

The retrieval time period 138 is the time period during which receipts and cart images are retrieved from the historical data 134. If the retrieval time period includes the time period from January 1 to January 31 of the current year, then receipts and paired cart images generated during transactions completed between January 1 and January 31 are retrieved and searched to identify receipts including the selected item ID. If the selected item is a rare item which is not frequently included in baskets of items purchased by customers (low frequency of purchase), the retrieval time period is extended. For example, instead of a one month retrieval time period, the retrieval time period is extended to two or three months. In other examples, the retrieval time period is a day, a few days, a week, a couple of weeks or any other time period. The adjustable retrieval time period enables a larger pool of receipts to be obtained for less common items from which to obtain receipt-image pairs.

The top ranked images 156, in some examples, are presented to one or more users for review and/or verification via a user interface, such as, but not limited to, the user interface device 110 and/or the UI device 120. The user reviews the top ranked images to verify that the cropped images are high quality images of the selected item in an absence of noise or other objects which are not of interest. A high quality image is an image in which the selected item is present in the image, the item is visible and unobstructed by other objects. In some embodiments, during verification, a human user reviews the cropped images and verifies the cropped images contain an image of the selected item. If not, the human user re-labels the image or filters the image out of the data set.

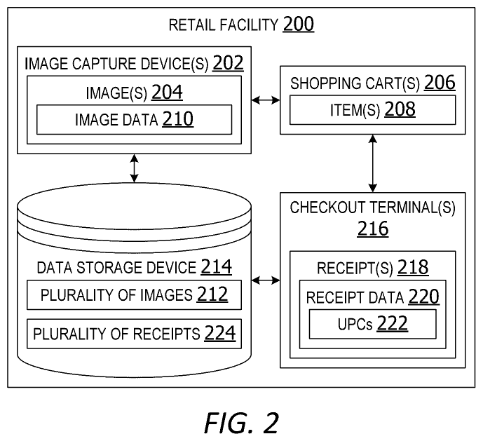

FIG. 2 is an exemplary block diagram illustrating a retail facility 200 including image capture devices and checkout terminals for generating receipts and cart images. The retail facility 200 is any type of brick-and-mortar facility, such as a retail store. One or more image capture device(s) 202 generating one or more image(s) 204 of one or more shopping cart(s) 206 containing one or more item(s) 208 being purchased or already purchased by one or more customers. The image capture device(s) 202, in some examples, include one or more digital cameras capturing digital images of the shopping cart(s) 206. The digital image(s) include image data 210.

The plurality of images 212 generated by the image capture device(s) 202 are optionally stored on a data storage device 214. The plurality of images 212 include cart images, such as, but not limited to, the cart image(s) 146 in FIG. 1. The data storage device 214 is a device for storing data, such as, but not limited to, the data storage device 132 in FIG. 1. In other examples, the plurality of images 212 are stored on a cloud storage, such as, but not limited to, the cloud server 118 in FIG. 1.

One or more checkout terminal(s) 216 generate one or more receipt(s) 218 including receipt data 220 associated with the purchase of one or more item(s) 208 purchased by customers. The checkout terminal(s) 216 include any type of checkout terminals, such as, but not limited to, a staffed POS device, a self-checkout device, a Scan-N-Go (SNG) device, or any other type of checkout device. The checkout terminal(s) 216 enable a user to complete a purchase transaction for one or more items and receive a receipt documenting the purchase transaction. The receipt data includes information, such as, but not limited to, a store ID, a checkout terminal ID, a time of purchase, date of purchase, item ID for each item purchased, number of items purchased, name of items purchased, description of items purchased, and/or type of payment provided to complete the purchase. In some embodiments, the receipt data includes a UPC 222 or other item ID for each item purchased. The plurality of receipts 224 and/or the plurality of images 212 generated within a given time period are stored as historical data on the data storage device 214 located in the retail facility. In other embodiments, the plurality of receipts 224 and/or the plurality of images 212 are stored on a cloud storage or other remote data storage device which is accessed via a network, such as, but not limited to, the network 112 in FIG. 1.

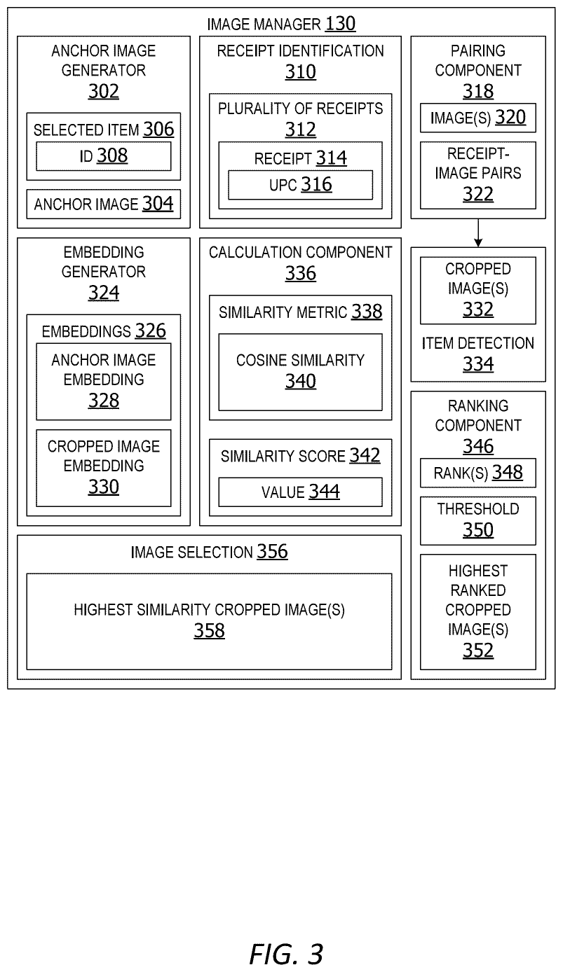

Turning now to FIG. 3, an exemplary block diagram illustrating an image manager 130 for generating image-based training data using progressive data curation is shown. In some embodiments, the image manager 130 includes an anchor image generator 302 for obtaining an anchor image 304 of a selected item 306 and/or a selected item ID 308. In this example, the anchor image generator 302 creates the anchor image based on a text description of the selected item. The anchor image generator 302 includes a deep learning model for creating images based on text, such as, but not limited to, a CLIP model.

In other embodiments, the anchor image generator 302 obtains the anchor image 304 from a database storing images of items. The database can include a local database, or a remote database accessed via a network. The anchor image generator optionally obtains one or more anchor images by submitting a search query including the item ID 308, a name of the selected item 306 and/or a text description of the selected item 306 to an online data source, such as a cloud server or search engine. One or more candidate anchor images are returned to the image manager 130 in response to the search query. The anchor image generator 302 selects an anchor image from the one or more anchor images obtained by the image manager 130.

A receipt identification 310 is a software component that searches a plurality of receipts 312 generated during the retrieval time period for receipts including the selected item 306 ID 308, such as, but not limited to, a UPC 316 associated with the selected item 306. The plurality of receipts 312 are receipts associated with transactions, such as, but not limited to, the receipt(s) 144 in FIG. 1 and/or the plurality of receipt(s) 218 in FIG. 2.

The image manager 130 retrieves one or more cart image(s) 320 from a plurality of images generated during the retrieval time period. In some embodiments, a pairing component 318 matching each receipt including at least one instance of the selected item with a cart image that corresponds to the receipt to one or more create a receipt-image pairs 322. In other words, when a customer purchases one or more items at a checkout terminal, a receipt 314 is generated recording the transaction. At least one cart image of the purchased items is also created. The pairing component pairs the receipt and cart image together for use in generating customized training data using progressive data curation.

An item detection 334 crops one or more of the cart images in the image(s) 320 containing the selected item 306 to remove noise from the image(s) 320 and isolate the selected item or portion of the selected item visible in each image. In some embodiments, the cropped image(s) 332 are generated by a pretrained CV object detection model.

An embedding generator 324 generates anchor image embeddings 326 for the anchor image 304. The anchor image embedding 326 is a numerical representation of the anchor image 304. The embedding generator 324 creates one or more cropped image embeddings 330 representing the cropped image(s) 332 of each item. In some examples, the embedding generator 324 includes a deep learning embedding model trained to generate embeddings representing images.

In some embodiments, a calculation component 336 applies a similarity metric 338 to calculate a similarity score 342 representing a degree of similarity between each cropped image embedding and the anchor image embedding 328. A similarity score 342 is generated for each embedding. If the cropped image embedding includes thirty embeddings, then the calculation component calculates thirty similarity scores 342. The similarity value 344 indicates how similar the cropped image represented by the cropped image embedding is to the anchor image 304. The higher the similarity score 342, the greater the similarity between the anchor image and a given cropped image. In this example, the similarity metric 338 is a cosine similarity 340.

A ranking component 346 generates one or more rank(s) 348 for the cropped image embeddings 330. The ranking component 346 assigns a rank to each cropped image and/or cropped image embedding based on the similarity scores 342 for the cropped image embeddings. The ranking component 346 selects a threshold 350 number of highest ranked cropped image(s) 352. The threshold 350 is a user-configurable threshold number of top “K” ranked cropped images.

The threshold number of highest ranked cropped image(s) is any user-configurable number of images. In some examples, the threshold number is fifty images. In other examples, the threshold number of highest ranked cropped images is ten image. In yet other examples, the threshold number of cropped images is sixty images.

In some embodiments, an image selection 356 identifies a set of one or more highest similarity cropped image(s) 358. The set of highest similarity cropped image(s) 358 optionally includes a user-configurable threshold number of images. The highest similarity cropped image(s) 358 are presented to one or more users via a user interface for review and verification (approval). If the images are approved, the images are added to training data used to train object detection models and/or object recognition models. If an image in the highest similarity cropped image(s) is rejected, a human user optionally corrects the labeling (re-labels) the image or the image is discarded.

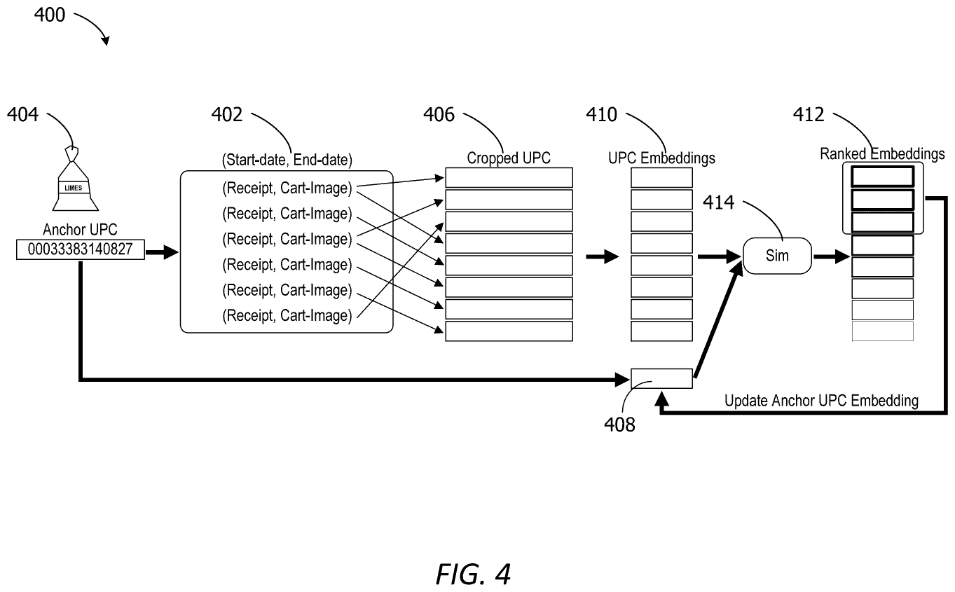

FIG. 4 is an exemplary block diagram illustrating a pipeline 400 of progressive data curation for generating images of a selected item for use in training data. For each UPC, the historical receipt information and progressive process are applied to obtain more high-quality images as candidates for use as training data. In this example, an anchor image is obtained. Historical receipts 402 and corresponding cropped images 406 are obtained. Embeddings of the anchor image 404 and cropped image embeddings 410 are generated. The embeddings are ranked 412 based on similarity 414 between the anchor image embedding 408 and the cropped image embeddings 410. The anchor image embeddings are updated using the top “K” highest ranked cropped image embeddings. The process of ranking the embeddings and updating the anchor image embeddings are repeated iteratively until a convergence is reached converting the embedding rankings to a stable state.

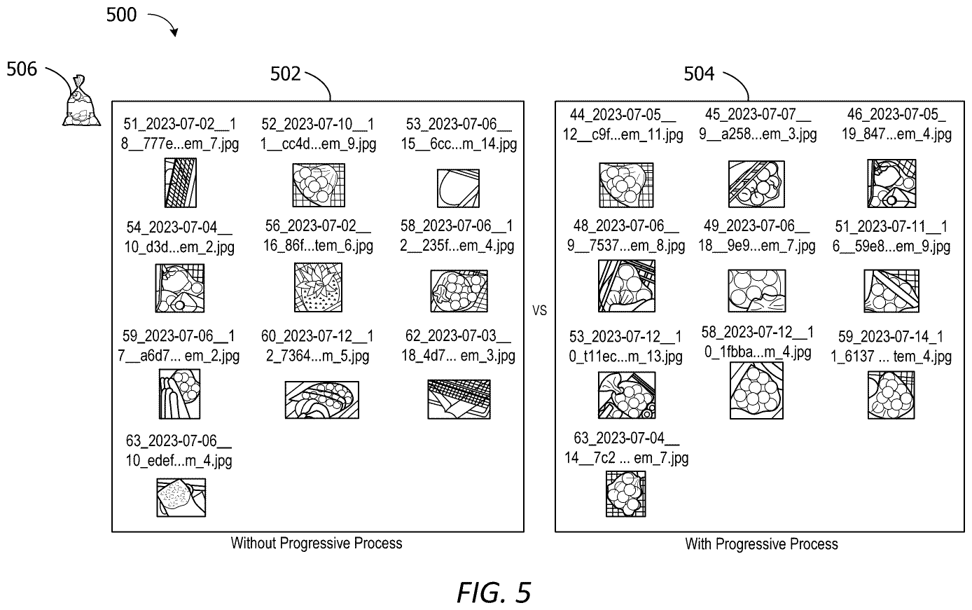

FIG. 5 is an exemplary diagram illustrating a set of images 500 of a selected item created without progressive data curation and with progressive data curation. The set of images 502 created without progressive data curation include erroneous results, such as images which are not the same or similar to the anchor image 506. The set of images 504 created with progressive data curation include images which are more similar to the anchor image 506, with fewer errors or false positives.

Referring now to FIG. 6, an exemplary flow chart illustrating operation of the computing device to generate sets of images for training data using progressive data curation is shown. The process 600 shown in FIG. 6 is performed by an image manager component, executing on a computing device, such as the computing device 102 or the user device 116 in FIG. 1.

The process begins by obtaining an anchor image at 602. The anchor image is selected from a plurality of available images in some embodiments. In other embodiments, the anchor image is generated using a trained deep learning model, such as a CLIP model. The image manager identifies receipts with the selected item at 604. The receipts are retrieved from a database of historical information, such as, but not limited to, the historical data 134 in FIG. 1. The receipts are paired with corresponding cart images at 606. Embeddings of the anchor image and the item images cropped from a cart image are generated at 608. The embeddings of each cropped item image are generated by an embedding model in this example.

In some embodiments, the embeddings are generated for images of the selected item cropped from the raw cart images of carts paired with the receipts. The image manager calculates a similarity between the anchor image embedding and the cropped image embeddings at 610. The cropped image embeddings are ranked at 612. The rankings are generated based on the calculated similarity between the anchor image embedding and the cropped image embeddings. A threshold number of cropped image embeddings are selected at 614. The selected threshold number of cropped image embeddings are the highest ranked cropped image embeddings. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to iteratively update anchor image embeddings and ranking cropped image embeddings based on calculated similarity during progressive data curation. The process 700 shown in FIG. 7 is performed by an image manager component, executing on a computing device, such as the computing device 102 or the user device 116 in FIG. 1.

The process begins by ranking each cropped image embedding based on similarity score(s) for the embeddings at 702. The image manager updates the anchor image embedding using a set of highest ranking cropped image embeddings at 704. A determination is made whether convergence of the rankings is attained at 706. If not, the process iteratively executes operations 702 through 706 until convergence is attained. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to apply a dynamic retrieval time period based on frequency of occurrence of each selected item in one or more receipts associated with purchase transaction and/or frequency with which an occurrence of an item in an image is detected. The process 800 shown in FIG. 8 is performed by an image manager component, executing on a computing device, such as the computing device 102 or the user device 116 in FIG. 1.

The process begins by identifying a selected item at 802. A determination of frequency of purchase of the selected item is made at 804. The frequency is determined based on the number of instances of the item purchased within a given time period and/or the number of receipts in which the item appears within a given time period. The time period can include a single day, several days, a week, a month, or any other time period. A determination is made whether the item is a common item at 806. The determination is made based on the frequency of purchase in this example. If not, an extended time retrieval time period is applied at 808. If the item is a common item, a shortened retrieval time period is applied at 810. The receipts including the selected item which are generated during the retrieval time period are retrieved at 812. The receipts are retrieved from a data storage device, such as a data storage device, a database, a cloud storage, or any other data store. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

### Additional Examples

To address the challenges of obtaining a large body of high quality training images for training CV item detection and/or item recognition models, the system uses historical data, such as past receipts generated within a user-configurable retrieval time period. The system obtains high-quality training images for each UPC based on the assumption that a product (item ID) listed on a receipt for a given customer basket is likely represented in the associated cart image of the same customer basket. This method improves the performance of item recognition model training, as well as performance of the CV models trained using the training image data generated by this system.

In some embodiments, the image manager acquires an anchor image for a given UPC. This can be sourced from vendor images, the internet, or by using the CLIP model with a corresponding description. The image manager identifies past receipts containing the specific UPC. Pair each retrieved receipt with its corresponding cart image. Within each cart image, the image manager detects all the items visible in each cart image. In some examples, the system identifies the UPC of each item captured in the cart images.

The image manager, in other embodiments, applies a pre-trained model to obtain embeddings for both the cropped images and the anchor image. The cropped image is an image of an individual item cropped from a cart image. The cropped item image, in some embodiments, contains only an image of the selected item. The choice of the pre-trained model is flexible, it can be the backbone of a classification model trained on the image public dataset in a supervised or self-supervised manner, or that of a fine-tuned model. A similarity metric, such as a cosine similarity, is used to rank the cropped image embeddings by calculating the similarity between anchor image embedding and all cropped image embeddings.

In some embodiments, the image manager updates the anchor image embedding by integrating the top ‘K’ cropped image embeddings. The image manager repeats the steps of calculating the similarity between the anchor image embedding and the cropped image embedding and then updating the anchor image embedding using the top ‘K’ cropped image embeddings through several iterations or until the convergence of cropped image providing a stable ranking of the cropped images is achieved. The image manager selects the top ‘M’ ranked cropped images to serve as the training data for each item or item ID (UPC).

Some embodiments provide an image manager to improve performance of an item recognition model in a retail store to obtain high-quality training images for each unique item UPC. The image manager leverages historical receipt information to gather a more extensive and diverse set of data for all the item UPCs. The image manager acquires an anchor image for a given UPC. The image manager identifies past receipts containing the specific UPC. The image manager pairs each retrieved receipt with its corresponding cart image. The image manager detects all the UPCs within each cart image. The image manager applies a pre-trained model to obtain embeddings for both the cropped images and the anchor image. The image manager uses a similarity metric to rank the cropped image embeddings based on the similarity between the anchor image and the cropped image embeddings. The image manager updates the anchor image embedding by integrating the top ‘K’ cropped image embeddings. The image manager selects the top ‘M’ ranked cropped images to serve as training data for each item UPC. The image manager progressively updates the anchor image embedding and ranking of the cropped image embeddings. The image manager addresses the imbalance issue in the training data by extending the retrieval time period for less common items.

In other embodiments, the system organizes images with categorical information rather than bounding boxes. The images are used to train object recognition models and/or classification models. The image data can also be used to train object detection models, as it can aid in categorizing bounding boxes if used.

Cropping the cart image from the raw image to isolate the image of the shopping cart and the plurality of items in the shopping cart. The system then crops individual items from the cart image. This assists in isolating different item UPCs. The system finds the cropped item/UPC image associated with the respective item/UPC from all these cropped images. The embedding is calculated for cropped item images instead of cart images.

Alternatively, or in addition to the other examples described herein, examples include any combination of the following:
update the anchor image embedding by integrating a set of highest similarity cropped image embeddings from the plurality of cropped image embeddings using the calculated similarity;
generate the anchor image by a contrastive language-image pretraining (CLIP) model based on a text description of the selected item;
retrieve a plurality of receipts generated within a dynamic retrieval time period including at least one instance of the selected item ID;
pair each receipt in the plurality of receipts with at least one cart, a cart image corresponding to the paired cart is obtained from a plurality of cart images, each cart image including an image of at least a portion of the selected item;
generating a cropped item image by cropping an image of a single selected item from a selected cart image, wherein an embedding is generated for the cropped item image;
detect a plurality of universal product codes (UPCs) associated with each item

in the cart image, wherein the cart image is cropped to isolate the image of the cart. The cart image is then cropped to isolate an image of each individual item visible in the cart image to eliminate images of items having a UPC which fails to correspond to a UPC of the selected item, wherein the cropped item image includes at least one item having a UPC corresponding to the UPC of the selected item;
apply a cosine similarity metric to rank the anchor image embedding and each cropped image embedding in the plurality of cropped image embeddings;
rank each cropped image embedding in the plurality of cropped image embeddings and update the anchor image embedding using a predetermined number of highest ranking cropped image embeddings iteratively until a convergence of cropped image embedding ranking is achieved;
obtaining an anchor image for a selected item identifier (ID) associated with a selected item in a retail facility;
identifying a receipt from a plurality of receipts containing the selected item ID in a data storage device, wherein the receipt is paired with a cart image associated with the identified receipt, the cart image comprising an image of a portion of the selected item;
generating, by a pre-trained embedding model, an anchor image embedding representing the anchor image and a cropped image embedding representing the image of the portion of the selected item;
calculating a similarity between the anchor image embedding and a plurality of cropped item image embeddings using a similarity metric, the plurality of cropped image embeddings including the cropped item image embedding representing the image of the portion of the selected item;
selecting a threshold number of cropped images from the plurality of cropped images corresponding to a set of highest similarity cropped image embeddings from the plurality of cropped image embeddings;
adding the selected threshold number of cropped images to a training data for the selected item, the training data stored in a database, wherein a computer vision object detection model is trained using the training data including the selected threshold number of cropped images;
determining a frequency of purchase of the selected item within a predetermined time period;
obtaining the anchor image by performing an online search via a network, wherein the anchor image is selected from a plurality of search results returned in response to a search query including a text description of the selected item;
retrieving a plurality of receipts generated within a user-configurable retrieval time period including at least one instance of the selected item ID;
pairing each receipt in the plurality of receipts with at least one cart image from a plurality of cart images, each cart image including an image of at least a portion of the selected item;
an embedding is generated for each item image cropped from the cart image;
identifying a plurality of universal product codes (UPCs) associated with each item image cropped from the cart image, wherein the cropped image includes at least one item having a UPC corresponding to the UPC of the selected item;
ranking each cropped image embedding in the plurality of cropped image embeddings;
updating the anchor image embedding using a predetermined number of highest ranking cropped image embeddings iteratively until a convergence of cropped image embedding ranking is achieved;
extending the retrieval time period responsive to a determination the selected item is an infrequently purchased item, wherein an infrequently purchased item is an item which is purchased a number of items within a predetermined time-period that is less than a threshold, and wherein a frequently purchased item is an item that is purchased a number of times within the predetermined time period that exceeds the threshold, the predetermined time period can include a day, a week, a month, or any other pre-determined time period;
reducing the retrieval time period responsive to a determination the selected item is a frequently purchased item;
applying a first retrieval time period for a first selected item having a first frequency of purchase;
applying a second retrieval time period for a second selected item having a second frequency of purchase;
applying a third retrieval time period for a third selected item having a third frequency of purchase, wherein a longer retrieval time period is applied for items that are rarely purchased, and wherein a shorter retrieval time period is applied for items that are commonly purchased, wherein a common item is an item that is frequently purchased and/or occurring frequently within images, and wherein an uncommon item is an item that is infrequently purchased and/or rarely occurring in images;
detecting the selected item in each cart image in the plurality of cart images;
cropping each cart image in the plurality of cart images to eliminate all objects except the selected item, wherein the cropped images include only an image of at least a portion of the selected item; and
applying a cosine similarity metric to rank the anchor image embedding and each cropped image embedding in the plurality of cropped image embeddings.

At least a portion of the functionality of the various elements in FIG. 1, FIG. 2, FIG. 3, FIG. 4, and FIG. 5 can be performed by other elements in FIG. 1, FIG. 2, FIG. 3, FIG. 4 and FIG. 5, or an entity (e.g., processor 106, web service, server, application program, computing device, etc.) not shown in FIG. 1, FIG. 2, FIG. 3, FIG. 4, and FIG. 5.

In some examples, the operations illustrated in FIG. 6, FIG. 7, and FIG. 8 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of generating image-based training data using progressive data curation, the method comprising obtaining an anchor image for a selected item identifier (ID) associated with a selected item in a retail facility; identifying a receipt from a plurality of receipts containing the selected item ID in a data storage device, wherein the receipt is paired with a cart image associated with the identified receipt, the cart image comprising an image of a portion of the selected item; generating, by a pre-trained embedding model, an anchor image embedding representing the anchor image and a cropped image embedding representing the image of the portion of the selected item; calculating a similarity between the anchor image embedding and a plurality of cropped image embeddings using a similarity metric, the plurality of cropped image embeddings including the cropped image embedding representing the image of the portion of the selected item; selecting a threshold number of cropped images from the plurality of cropped images corresponding to a set of highest similarity cropped image embeddings from the plurality of cropped image embeddings; and adding the selected threshold number of cropped images to a training data for the selected item, the training data stored in a database, wherein a computer vision object detection model is trained using the training data including the selected threshold number of cropped images.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for generating image-based training data using progressive data curation. For example, the elements illustrated in FIG. 1, FIG. 2, FIG. 3, FIG. 4, and FIG. 5, such as when encoded to perform the operations illustrated in FIG. 6, FIG. 7, and FIG. 8, constitute exemplary means for acquiring an anchor image for a selected item identifier (ID) associated with a selected item in a retail facility; exemplary means for identifying a receipt from a plurality of receipts containing the selected item ID in a data storage device, wherein the receipt is paired with a cart image associated with the identified receipt, the cart image comprising an image of a portion of the selected item; exemplary means for generating an anchor image embedding representing the anchor image and a cropped image embedding representing the image of the portion of the selected item; exemplary means for calculating a similarity between the anchor image embedding and a plurality of cropped image embeddings using a similarity metric, the plurality of cropped image embeddings including the cropped image embedding representing the image of the portion of the selected item; and exemplary means for selecting a threshold number of cropped images from the plurality of cropped images corresponding to a set of highest similarity cropped image embeddings from the plurality of cropped image embeddings, wherein the selected threshold number of cropped images are added to a set of training images for the selected item.

Other non-limiting examples provide one or more computer storage devices having a first computer-executable instructions stored thereon for providing generating image-based training data using progressive data curation. When executed by a computer, the computer performs operations including selecting an anchor image of a selected item identifier (ID) associated with a selected item in a retail facility from a plurality of images of the selected item obtained from a data storage device via a network; identifying a receipt from a plurality of receipts containing the selected item ID in a data storage device generated within a retrieval time period, wherein the receipt is paired with a cart image associated with the identified receipt, the cart image comprising an image of a portion of the selected item; generating, by a pre-trained embedding model, an anchor image embedding representing the anchor image and a cropped image embedding representing the image of the portion of the selected item; calculating a similarity between the anchor image embedding and a plurality of cropped image embeddings using a similarity metric, the plurality of cropped image embeddings including the cropped image embedding representing the image of the portion of the selected item; updating the anchor image embedding by integrating a set of highest similarity cropped image embeddings from the plurality of cropped image embeddings using the calculated similarity; calculating a similarity between the updated anchor image embedding and the plurality of cropped image embeddings using the similarity metric; ranking the plurality of cropped image embeddings based on the calculated similarity between the updated anchor image embedding and the plurality of cropped image embeddings; and selecting a threshold number of cropped images from the plurality of cropped images corresponding to a set of highest similarity cropped image embeddings from the plurality of cropped image embeddings based on the rankings, wherein the selected threshold number of cropped images are added to a set of training images for the selected item.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ ”only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for generating image-based training data, the system comprising:
a processor; and
a computer-readable medium storing instructions that are operative upon execution by the processor to:
acquire an anchor image for a selected item identifier (ID) associated with a selected item in a retail facility;
identify a receipt from a plurality of receipts containing the selected item ID in a data storage device and a cart image corresponding to a cart paired with the identified receipt, the cart image associated with the cart comprising an image of a portion of the selected item;
generate, by a pre-trained embedding model, an anchor image embedding representing the anchor image and a cropped image embedding representing the image of the portion of the selected item;
calculate a similarity between the anchor image embedding and a plurality of cropped image embeddings using a similarity metric, the plurality of cropped image embeddings including the cropped image embedding representing the image of the portion of the selected item;
select a threshold number of cropped images from a plurality of cropped images corresponding to a set of highest similarity cropped image embeddings from the plurality of cropped image embeddings; and
generate training data comprising the selected threshold number of cropped images for the selected item.

2. The system of claim 1, wherein the instructions are further operative to:
update the anchor image embedding by integrating the set of highest similarity cropped image embeddings from the plurality of cropped image embeddings using the calculated similarity.

3. The system of claim 1, wherein the instructions are further operative to:
generate the anchor image by a contrastive language-image pretraining (CLIP) model based on a text description of the selected item.

4. The system of claim 1, wherein the instructions are further operative to:
retrieve the plurality of receipts generated within a dynamic retrieval time period including at least one instance of the selected item ID; and
pair each receipt in the plurality of receipts with at least one cart image from a plurality of cart images, each cart image including an image of at least a portion of the selected item, wherein an embedding is generated for each cropped item image.

5. The system of claim 1, wherein the instructions are further operative to:
detect a plurality of item IDs associated with each item in the cart image, wherein an image of each item is cropped from the cart image, wherein each cropped item image includes at least a portion of one item having an item ID corresponding to the item ID of the selected item.

6. The system of claim 1, wherein the instructions are further operative to:
apply a cosine similarity metric to rank the anchor image embedding and each cropped image embedding in the plurality of cropped image embeddings.

7. The system of claim 1, wherein the instructions are further operative to:
rank each cropped image embedding in the plurality of cropped image embeddings and update the anchor image embedding using a predetermined number of highest ranking cropped image embeddings iteratively until a convergence of cropped image embedding ranking is achieved.

8. A method for generating image-based training data, the method comprising:
obtaining an anchor image for a selected item identifier (ID) associated with a selected item;
identifying a receipt from a plurality of receipts containing the selected item ID in a data storage device, wherein the receipt is paired with a cart image associated with the identified receipt, the cart image comprising an image of a portion of the selected item;
generating, by a pre-trained embedding model, an anchor image embedding representing the anchor image and a cropped image embedding representing the image of the portion of the selected item;
calculating a similarity between the anchor image embedding and a plurality of cropped image embeddings using a similarity metric, the plurality of cropped image embeddings including the cropped image embedding representing the image of the portion of the selected item;
selecting a threshold number of cropped images from a plurality of cropped images corresponding to a set of highest similarity cropped image embeddings from the plurality of cropped image embeddings; and
generate training data, the training data comprising the selected threshold number of cropped images for the selected item, the training data stored in a database, wherein a computer vision object recognition model is trained using the training data including the selected threshold number of cropped images.

9. The method of claim 8, further comprising:
determining a frequency of occurrence of the selected item within a predetermined time period;
applying a first retrieval time period for retrieving receipts including the selected item in response to determining the selected item is a common item; and
applying a second retrieval time period in response to determining the selected item is an uncommon item, wherein the second retrieval time period is longer than the first retrieval time period.

10. The method of claim 8, further comprising:
obtaining the anchor image by performing an online search via a network, wherein the anchor image is selected from a plurality of search results.

11. The method of claim 8, further comprising:
retrieving a plurality of receipts generated within a user-configurable retrieval time period including at least one instance of the selected item ID;
pairing each receipt in the plurality of receipts with at least one cart image from a plurality of cart images, each cart image including an image of at least a portion of the selected item; and
generating a cropped item image by cropping an image of a single selected item from a selected cart image, wherein an embedding is generated for the cropped item image.

12. The method of claim 8, further comprising:
identifying a plurality of item IDs associated with each item in the cart image, wherein an image of each item is cropped from the cart image, wherein the cropped item image includes at least a portion of the item having an item ID corresponding to the item ID of the selected item.

13. The method of claim 8, further comprising:
applying a cosine similarity metric to rank the anchor image embedding and each cropped image embedding in the plurality of cropped image embeddings.

14. The method of claim 8, further comprising:
ranking each cropped image embedding in the plurality of cropped image embeddings; and
updating the anchor image embedding using a predetermined number of highest ranking cropped image embeddings iteratively until a convergence of cropped image embedding ranking is achieved.

15. One or more computer storage devices having computer-executable instructions stored thereon, which, upon execution by a computer, cause the computer to perform operations comprising:
selecting an anchor image of a selected item identifier (ID) associated with a selected item from a plurality of images of the selected item obtained from a data storage device via a network;
identifying a receipt from a plurality of receipts containing the selected item ID in the data storage device generated within a retrieval time period, wherein the receipt is paired with a cart image associated with the identified receipt, the cart image comprising an image of a portion of the selected item;
generating, by a pre-trained embedding model, an anchor image embedding representing the anchor image and a cropped image embedding representing the image of the portion of the selected item;
calculating a similarity between the anchor image embedding and a plurality of cropped image embeddings using a similarity metric, the plurality of cropped image embeddings including the cropped image embedding representing the image of the portion of the selected item;
updating the anchor image embedding by integrating a set of highest similarity cropped image embeddings from the plurality of cropped image embeddings using the calculated similarity;
calculating a similarity between the updated anchor image embedding and the plurality of cropped image embeddings using the similarity metric;
ranking the plurality of cropped image embeddings based on the calculated similarity between the updated anchor image embedding and the plurality of cropped image embeddings;
selecting a threshold number of cropped images from a plurality of cropped images corresponding to a set of highest similarity cropped image embeddings from the plurality of cropped image embeddings based on the rankings; and
generate a set of training images comprising the selected threshold number of cropped images for the selected item.

16. The one or more computer storage devices of claim 15, wherein the operations further comprise:
extending the retrieval time period responsive to a determination the selected item is an uncommon item.

17. The one or more computer storage devices of claim 15, wherein the operations further comprise:
reducing the retrieval time period responsive to a determination the selected item is a common item.

18. The one or more computer storage devices of claim 15, wherein the operations further comprise:
applying a first retrieval time period for a first selected item having a first frequency of occurrence;
applying a second retrieval time period for a second selected item having a second frequency of occurrence; and
applying a third retrieval time period for a third selected item having a third frequency of occurrence, wherein a longer retrieval time period is applied for uncommon items, and wherein a shorter retrieval time period is applied for common items.

19. The one or more computer storage devices of claim 15, wherein the operations further comprise:
detecting the selected item in each cart image in a plurality of cart images, wherein an image of the selected item is cropped from each cart image in the plurality of cart images.

20. The one or more computer storage devices of claim 15, wherein the operations further comprise:
applying a cosine similarity metric to rank the anchor image embedding and each cropped image embedding in the plurality of cropped image embeddings.
